(19) United States
(12) Patent Application Publication
(10) Pub. No.: US 2014/0108621 A1
(43) Pub. Date: Apr. 17, 2014

(54) SYSTEM AND METHOD FOR INTERNET SERVICES AGGREGATION

(71) Applicant: Hubbley, LLC, Davie, FL (US)

(72) Inventors: Larry Bryan, Plantation, FL (US); Rick Apseloff, Davie, FL (US); Glenn Eisenberg, Park City, UT (US); Brian Schultz, Sunrise, FL (US); Willie Morris, Fort Lauderdale, FL (US); James Kluetz, Fort Lauderdale, FL (US); Joseph Russoniello, Fort Lauderdale, FL (US); Larry Talley, Boynton Beach, FL (US); Patrick Verrier, Cooper City, FL (US); Steve Bryson, Kaysville, UT (US)

(73) Assignee: Hubbley, LLC, Davie, FL (US)

(21) Appl. No.: 14/093,498

(22) Filed: Dec. 1, 2013

Related U.S. Application Data
(63) Continuation-in-part of application No. PCT/US12/40551, filed on Jun. 1, 2012.

(51) Int. Cl. H04L 29/08; G06F 17/22

(52) U.S. Cl. CPC H04L 67/02; G06F 17/2247
USPC 709/219; 715/234

(57) ABSTRACT

A system and method for aggregation of information over the Internet and presentation of that information, including systems and methods for real-time updating of that information, is disclosed. The system and method includes the use of an application server as part of a broader application that serves as a proxy for a user's browser. The system and method further filters information on a user's social media accounts and other Internet accounts and presentation of that filtered information, including systems and methods for real-time updating of filtered information.

### RELATED APPLICATIONS

This application claims the benefit of U.S. Provisional Patent Application Ser. No. 61/492,342, filed on Jun. 1, 2011 and titled System and Method for Internet Services Aggregation and U.S. Provisional Patent Application Ser. No. 61/621,628, filed on Apr. 9, 2012 and titled System and Method for Application Server as Proxy for Browser, the contents of each which are hereby incorporated herein by reference in their entirety. This application is a continuation-in-part of PCT Application No. PCT/US12/40551, filed on Jun. 1, 2012 and titled System and Method for Internet Services Aggregation.

### FIELD OF THE INVENTION

This application relates to a system and method for aggregation of information over the Internet and presentation of that information, including systems and methods for real-time updating of that information. The system and method includes the use of an application server as part of a broader application that serves as a proxy for a user's browser. The system and method further filters information on a user's social media accounts and other Internet accounts and presentation of that filtered information, including systems and methods for real-time updating of filtered information.

### BACKGROUND OF THE INVENTION

Undoubtedly, the Internet has completely changed the way many people (and businesses) manage their time, their businesses, their jobs and their social lives. Recently, the Pew Project for Excellence in Journalism found in a survey that 41% of the respondents get most of their news online. While overall television was the primary source of news for respondents, 65% of 18-to-29-year-olds said that the Internet was their main news source. Besides reading news, people find dates; shop; socially interact; share and listen to music, videos and photographs; and conduct business on the Internet. Internet users often have accounts on many different social media websites.

There are many ways to access the Internet, from desktop and laptop computers to smartphones to portable Internet devices such as notebooks, tablets and sliders. The Internet can be accessed today through a variety of technologies, from wired networks to wireless networks. Wireless networks may be accessed through a device within 100 feet of the source using, for example, Bluetooth, ZigBee or RFID; Wi-Fi can allow a device to access the Internet anywhere from 500 feet to several miles from a hotspot; and WiMAX, MIT-2000 and other long-range technologies can allow Internet communication up to 150 miles from a base station or across the country as a networked service. Other long-range technologies include high- and low-altitude platform stations (HAPS/LAPS) and satellites.

It is not only ways of connecting to the Internet that is dramatically increasingly; the number of applications available for Internet users is likewise exploding. Generally, a user must access each application individually. For example, a user must login to Twitter® or Facebook® separately to read or post updates and to send messages. Then, the user must access his email, blogs, video posts, etc. Throughout the day, a user may access at least five (5) and easily fifteen (15) or more separate Internet services and websites to keep in touch with his friends and their business or job. Each service typically requires a separate user name and password. Sometimes, a user cannot use the same user name and password on each of her services because they are either already taken, or they do not meet the same security criteria. Keeping track of all the different user names and passwords becomes troublesome when the user wants to access his Internet sites from a remote computer, where he has not (and likely does not want to) keep that type of information stored.

Some social media aggregation websites have developed to help users access their separate Internet services from one location. For example, Facebook® allows users to access other services such as Twitter® or Flickr® on its site. This is typically performed through the use of an Application Programming Interface, or API. APIs enable an open architecture for sharing content and data between communities and applications such that content that is created in one place can be dynamically posted and updated in multiple locations on the web. In the context of web development, an API is typically a defined set of Hypertext Transfer Protocol (HTTP) request messages, along with a definition of the structure of response messages, which is usually in an Extensible Markup Language (XML) or JavaScript Object Notation (JSON) format. The so-called Web 2.0 has been moving away from Simple Object Access Protocol (SOAP) based services towards more direct Representational State Transfer (REST) style communications. Web APIs allow the combination of multiple services into new applications known as mashups. OpenSocial is a set of common APIs for web-based social network applications, developed by Google along with MySpace and a number of other social networks.

Some developers have approached the issue of simplifying multiple logins by developing an open standard called “Open ID” that authenticates users in a decentralized manner. The OpenID protocol does not rely on a central authority to authenticate a user's identity. Rather, the user interacts with a relying party (such as a website) that provides a means by which to specify an OpenID for the purposes of authentication; an end-user typically has previously registered an OpenID (e.g. alice.openid.example.org) with an OpenID provider such as AOL®, Google®, MySpace®, PayPal® and Yahoo!®

Some developers have developed desktop programs for managing specific networks. For example, Iconfactory™'s Twitterrific™ for Twitter® feeds, and Infinite Sushi™'s free 1001™ for Flickr® feeds. Apparent Software™ offers Socialite™, a desktop program that allows several social networks to be followed from a single application, and also allows RSS feeds to be viewed. ProfileLinker™ from Conduit is a “community” toolbar that can be downloaded that allows a user to easily access social network sites. Flock™ is a web browser that streams updates on social network sites and allows sharing of content located during web surfing to be shared over social networks.

Hubbley™ is a service provider for aggregation of a user's social media, email, calendar, contacts, search engines, photos, videos, files, news and shopping, among other features. After choosing which sites and services to aggregate, the user only needs to log in once to the Hubbley™ website to access all of his information.

Sometimes users want to focus on information on specific topics, For example, there may be a news item or updates on a friend's status that the user would like to find out about. However, having to pore through her many sites and services to find posts or stories on her particular topic is time consuming and not efficient.

### SUMMARY OF THE INVENTION

The system and method of the invention comprises a main web application accessed through a website (or “site”) where a user can register and access information pulled into the site from her favorite and/or most used Internet applications, services and sites. The applications that can be accessed include, but are not limited to, email; calendar; contacts; notes; tasks; social networks; blogs; messaging; news feeds; Internet search; online shopping; RSS feeds; video download and upload applications; music; photograph download and upload applications; and any other source of information available on the Internet. The system and method of the invention further includes a function to present applications, services and websites that may be of interest to the user. Additionally, the system and method of the invention comprises the use of an application server as part of a broader application that serves as a proxy for a user's browser.

The website is accessible over any communications network, whether wired or wireless, known or later developed. Any device configured to access the communications network and configured to render the pages of the website can be used.

In one embodiment, the invention relates to a system of aggregating and displaying information obtained from the Internet, comprising (a) a website hosted on one or more application servers; (b) one or more searchable databases hosted on one or more database servers, wherein the database servers are in communication with the application servers; (c) a programmable processor in communication with the application servers and the database servers; and (d) a communications link connecting the website to a communications network to a plurality of user web-enabled devices, wherein each user accesses the website through a browser program resident on the user web-enabled devices; wherein the application servers communicate with a plurality of services and applications available on the Internet via application programming interfaces and exchange information with those services and applications, wherein further the information received from the services and applications are displayed on the user web-enabled devices in response to predetermined selections made by the user.

In one embodiment, the invention relates to a method of using a proxy server that allows users to receive updates to any available online information in real-time without requiring the user's browsers to constantly poll their different services at predefined intervals, comprising (a) determining which of a plurality of application servers in communication with a proxy server has the least load and storing the identification of that application server in a session of a user of a web-based system; (b) receiving a background HTTP/HTTPS request launched by the user's browser that connects to the application server that was selected for that session; (c) retrieving access information for a plurality of the user's third-party Internet services and application from a database hosted on a database server in communication with the selected application server and creating an entry in an internal service update queue; (d) refraining from responding to the browser HTTP/HTTPS request thus keeping the browser connected to the application server; (e) inquiring at predetermined time intervals for updates to all of the user services and applications for users included in the internal service update queue; (f) transmitting to the user browser updates received by the selected application server in response to its inquiries for updates to the user services and applications; (g) reconnecting the user browser to the application server; and (h) deleting the user from the service update queue of the selected application server upon closing of the user browser.

In one embodiment, the invention relates to a computer software product that includes a non-transitory storage medium readable by a processor, the non-transitory storage medium having stored thereon a set of instructions for having a server serve as a proxy for a user's browser, the instructions comprising: (a) a first sequence of instructions which, when executed by the processor, causes the processor to determine which of a plurality of application servers in communication with a proxy server has the least load and store the identification of that application server in a session of a user of a web-based system; (b) a second sequence of instructions which, when executed by the processor, causes the web browser of the user to launch a background HTTP/HTTPS request that connects to the application server that was selected for that session; (c) a third sequence of instructions which, when executed by the processor, causes the selected application server to retrieve access information for a plurality of the user's third-party Internet services and application from a database hosted on a database server in communication with the selected application server and creates an entry in an internal service update queue; (d) a fourth sequence of instructions which, when executed by the processor, causes the selected application server to refrain from responding to the browser HTTP/HTTPS request thus keeping the browser connected to the application server; (e) a fifth sequence of instructions which, when executed by the processor, causes the selected application server to inquire at predetermined time intervals for updates to all of the user services and applications for users included in the internal service update queue; (f) a sixth sequence of instructions which, when executed by the processor, causes the user browser to process updates received from the selected application server in response to its inquiries for updates to the user services and applications; (g) a seventh sequence of instructions which, when executed by the processor, causes the user browser to reconnect to the selected application server and to continue to listen for further updates; and (h) an eighth sequence of instructions which, when executed by the processor, causes the application server to delete the user from its service update queue upon closing of the user browser.

In one embodiment, the invention relates to a system for using a server as a proxy for a user's browser, comprising a proxy server in communication with a plurality of web servers and a plurality of users via their web browser; a database server in communication with the web servers and a plurality of application servers; and a plurality of third-party services available on the Internet, wherein the web servers are configured to determine which of the application servers in communication with a proxy server has the least load and store the identification of that application server in a session of a user of the system; wherein further the system receives a background HTTP/HTTPS request launched by the user's browser that connects to the application server that was selected for that session; wherein further the selected application server retrieves access information for a plurality of the user's third-party Internet services and application from a database hosted on the database server and creates an entry in an internal service update queue; wherein further the system refrains from responding to the browser HTTP/HTTPS request thus keeping the browser connected to the application server; wherein further the selected application server inquires at predetermined time intervals for updates to all of the user services and applications for users included in the internal service update queue; wherein further the system transmits to the user browser updates received by the selected application server in response to its inquiries for updates to the user services and applications; wherein further the system reconnects the user browser to the application server; and wherein further the user is deleted from the service update queue of the selected application server upon closing of the user browser.

In one embodiment, the invention relates to a system of aggregating and displaying information obtained from the Internet, comprising (a) a website hosted on one or more application servers; (b) one or more searchable databases hosted on one or more database servers, wherein the database servers are in communication with the application servers; (c) a programmable processor in communication with the application servers and the database servers; and (d) a communications link connecting the website to a communications network to a plurality of user web-enabled devices, wherein each user accesses the website through a browser program resident on the user web-enabled devices; wherein the application servers communicate with a plurality of services and applications available on the Internet via application programming interfaces and exchange information with those services and applications, wherein further the information received from the services and applications are displayed on the user web-enabled devices in response to predetermined selections made by the user, wherein further the user selects one or more keywords and one or more services and applications such that all existing and incoming information in those services and applications that are found when searching using the selected keywords are displayed on the user's device. The services and applications can be searched by any method now known or later developed, for example Boolean searching that combines the selected keywords with operators such as AND, NOT and OR to further produce more relevant results.

### BRIEF DESCRIPTION OF THE DRAWINGS

The invention will be described with reference to the accompanying drawings, in which like elements are referenced with like numerals.

FIG. 1 is a schematic depicting one embodiment of the system of the invention.

FIG. 2 is a flowscheme of signing up for the service according to one embodiment of the invention.

FIG. 3 depicts a screenshot showing various services and applications that could be offered for selection by a user of the service according to one embodiment of the invention.

FIG. 4 depicts a screenshot from the account of a user who has aggregated various social media services for viewing in a single screen according to one embodiment of the invention.

FIG. 5 depicts a screenshot from the account of a user who has aggregated various social media services and also aggregated various messaging services and applications for viewing in a single screen according to one embodiment of the invention.

FIG. 6 depicts a screenshot from the account of a user who is posting a message on one or more of the social media services aggregated in the user's account according to one embodiment of the invention.

FIG. 7 depicts a screenshot from the account of a user who has aggregated various social media services; who has also aggregated various messaging services and applications; and who has also aggregated various calendar entries for viewing in a single screen according to one embodiment of the invention.

FIG. 8 depicts a screenshot from the account of a user who has conducted an Internet search and who has aggregated organic search results from a plurality of search engines for viewing in a single screen according to one embodiment of the invention.

FIG. 9 is a schematic depicting an application server available as part of a broader application that serves as a proxy for a user's browser.

FIG. 10 depicts a screenshot from the account of a user who has selected one or more keywords to search the information contained in one or more services and applications previously selected by the user.

### DETAILED DESCRIPTION OF THE INVENTION

The system and method of the invention comprises a main web application accessed at a website (or “site”) where a user can register and access information pulled into the site from other Internet applications, services and sites. In one embodiment, the system and method of the invention provides a rolling “ticker” of information on a display screen from which the user can make selections. The information in the “ticker” can include news stories or tasks entered by the user. The user can access the stories or information by clicking on an item as it scrolls across the user's screen. In one embodiment, the system and method of the invention provides custom server software which allows users to receive updates to any available online information, including but not limited to their social and messaging streams, in real-time without requiring their browsers to constantly poll their different services at predefined intervals.

In one embodiment, the applications and services that can be accessed and presented on the website include, but are not limited to, email; calendar; contacts; notes; tasks; social networks; blogs; messaging; news feeds; Internet search; online shopping; RSS feeds; video download and upload applications; music; and photograph download and upload applications. The system and method of the invention further includes a function to present applications, services and websites that may be of interest to the user. In one embodiment, the user can access any information available over the Internet and view that information on the website of the invention. For example, information regarding inventory or other business data can be accessed and presented.

The system comprises a main web application accessed on a website that is hosted on one or more servers. The website further comprises one or more databases, a programmable processor, and a communications link to a communications network. The website is accessible over the communications network to a plurality of users. Databases are configured to store information relating to each user, including the user's social media login information and login information for other sites accessed by the user on the Internet. The programmable processor of the website can be configured to access information in the database in response to user inputs.

The system can be used by any user who can access the website over any known or later developed communications network by any suitable device now known or later developed, including but not limited to general purpose computers; laptop computers; thin clients; PDAs; cell phones; satellite phones; and smartphones. The device must be capable of rendering and displaying pages created by any markup language now known or later developed which are transmitted over the communications network by the website by any web browser program now known or later developed. Suitable markup languages include, but are not limited, to, HTML and XHTML. Suitable web browser programs include, but are not limited to, Google Chrome™, Internet Explorer™, and Mozilla Firefox™.

The website comprises a plurality of web pages hosted on one or more servers accessed over the communications network by way of a locator address, such as a URL or URI. The one or more servers include or are in communication with a central processing unit (“CPU”), or processor; a communications link to the communications network; and one or more searchable databases.

A user who wishes to access information via the system accesses the website through a web-enabled device. After entering the URL of the website into the web browser program of the device, a communications link is established between a web browser program resident on the user's device (the “client”) and the website server (the “server”). The user's device may access the website over any wired or wireless network now known or later developed, for example via a WAN, LAN, MAN, Bluetooth, Ethernet, Wi-Fi, satellite, GSM or PCS.

When a user first accesses the website, he will be given the option to set up an account. He will be asked to provide information to login as well as authentication information for later accessing the system. This information is stored in one or more searchable databases, typically in an encrypted format. Additionally, the user will be asked to identify the Internet-based applications, sites and services that he has accounts and would like to access those streams of information through the portal of the system. He will be asked to enter login information for each Internet application, site and service, which will be stored in encrypted format along with his login information. He may also be asked for information on his interests which can be used to present him with websites and applications that may be of interest. Also, this information may be used for marketing other products and services that may be of interest.

Once the user has made his selections, the system configures a home page comprising a “dashboard” that is customized to that user. The user can customize his home page by theme, color, layout, etc. In one embodiment, the home page is customized by the system. The “dashboard” will present the user with a plurality of tabs representing different categories of Internet sites and applications, for example Social Networking; Tasks; Messaging; News Feeds; etc. The user may customize the presentation of the “dashboard” in some embodiments of the invention. The “dashboard” can also present other information, such as advertising and Internet sites, applications, products and services that may be of interest to the user based on his selections and stated interests.

From the “dashboard,” the user may select one or more “tabs,” and all of the information streams from the user's registered Internet sites, services and applications that are categorized under that “tab” will be rendered. Further, information from those Internet sites, services and applications are merged into a single stream of information that can be sorted by different criteria, such as sender, time or date. Each entry in the stream will identify the particular Internet application, site or service that provided the entry. Each entry will provide the user the option to take actions with respect to that entry, which options will be customized according to the particular Internet site, service or application. The user can review information for each tab. In one embodiment, the user can open multiple tabs for rendering streams from multiple categories on one screen at the same time. For example, multiple tabs may be opened to render the information streams from three different Internet sites and applications side-by-side on the user's screen.

Below is information particular to some of the different information streams that may be registered with the system of the invention. While this description relates primarily to social media networks and commercially available applications, the invention is not intended to be so limited and the system and method of acquiring and aggregating information from the Internet can be applied to any stream of information, such as, for example, inventory information or other data of interest to the user.

E-Mail

Most of the user's email accounts will be accessible from one screen without having to log into each one individually in one mailbox, identified by provider. The number of unread emails will be provided upon login. The user can send one message to an individual and have it “blown” out to all of her communication avenues, i.e. to her e-mail accounts, Twitter®, Linked®, Facebook®, etc.

a. Pop3, IMAP, Gmail, Facebook, LinkedIn, Yahoo, etc.

b. Functionality-compose, read, delete, forward, save, (all basic functionality), sort by date, provider, from, to.

Tools

The system has a custom built calendar with the ability to import appointments, tasks, notes, etc. from certain other calendars that the user is currently using. A custom built contact manager has the ability to import contacts from certain other contact managers, i.e. Outlook, Google, etc. Various web based applications such as Dictonary.com, Thesaurus.com, and Microsoft Office Online are all available in one convenient window.

Calendar

a. Day, week, month, year views as well as a view of upcoming appointments.

b. Functionality-enter item, delete item, revise item, all by date and length of time.

c. Ability to import calendar from sources such as, Google, Outlook, etc.

d. Calendar entries are able to have reminders set.

Contacts

a. Fields to include: picture, name, personal email, work email, company name, home phone, cell phone, work phone, home fax, work fax, other phone, home address, work address, other address, birthday (when keyed to enter on calendar), anniversary (when keyed to enter on calendar), web address.

b. Ability to enter new contact and to revise any current one.

c. Ability to import from sources such as Google, Outlook, etc.

Notes

a. Notes as in Outlook.

b. Ability to enter and revise as well as delete.

Task/To Do

a. Ability to enter, revise and delete To Do's.

b. Can indicate % done as in Outlook.

c. If a due date is given it should be on the calendar with a reminder.

Social Network

The user will have the ability to view her social networks all in one stream without having to navigate to separate websites or screens within an application. She can “blast” out her status to all of her social networks at one time from one window. She can also search for friends that are subscribers to the system and, once found, can quickly and easily add them to her social networks and to her contact list.

a. Social network area will have Facebook®, Twitter®, Linked In®, MySpace® and the blast button to blast status.

b. When clicked, the blast button will open a dialogue box where the user can key her status and will have radio buttons for each social network, one button for all social networks and a send button.

Search

The user has the ability to search the three largest search engines and return results in one window without returning duplications.

a. Web search function for Yahoo!®, Google®, Bing®, which the user will have the choice to use together or individually.

b. Results are combined with no duplication where available; results will indicate which search engine returned the results.

c. The user will be able to choose to search the web or the site of the system.

RSS Feeds

a. In the subscriber preferences page there will be a place to choose RSS feeds.

b. RSS feeds can include, weather, sports, news.

Music

a. Music service, such as Pandora®, icon/button is hard keyed and docked on the subscriber's dashboard and when used a control panel will become available.

Video

a. Video services, such as YouTube®, have a hard keyed favorite button on the search browser.

Information Ticker

There is an information ticker that scrolls on the user's home page from which the user can add feeds from their upcoming appointments, holidays, RSS feeds, social network updates, messages, etc. The user can click on information scrolling in the ticker and:
i. Go to the link and read the information.
ii. Email a link to any email address.
iii. Post a link on a social network site, such as Facebook®.
iv. Tweet a link.
v. Tweet and post a link on Facebook® at the same time.

a. The user will be able to turn the ticker on and off by accessing an account settings feature.

b. Information to be tagged to the ticker can include; upcoming appointments, incoming emails, RSS feeds (news, weather, sports), Facebook® feeds, Twitter® feeds, LinkedIn® feeds.

c. The icons in the ticker can be color coded based on the colors chosen by the system or the user, i.e. if social network is coded blue, then all social feed icons would be in blue text.

d. If the user puts her cursor over a ticker feed, it will stop the ticker so she can read it; if she clicks it, a box opens from where she can click the link and go to it, email it, Tweet it, post it or take all three actions.

Must See

a. There is a Must See button that the system selects to present to the user; selection can be based on his preferences and registered Internet sites and applications, or can be selected at the discretion of the system.

b. When the subscriber logs in and there are new Must Sees, there can be a button that will turn red and blink for 15-20 seconds to alert the user that there is a new Must See.

Print Buttons

a. All pages have a print screen/report button.

Help Area

a. There is a hard coded help button on the user's dashboard.

b. There is a searchable help database for the system.

Favorites/Bookmarks

a. On the search page there is a favorites/bookmarks link.

View Size

a. As a user opens a category, such as email, there are three column width sizes offered. It defaults to the largest size and the user may downsize to the other two.

b. When a user opens her page, the system remembers what was last opened and to what size and will open the next time to where it was when it was closed.

Advertising

The system has an extensive program that the user may opt in for that identifies the user's shopping preferences, which information can be communicated to retailers/wholesalers. With the shopping information that is given to the retailers/wholesalers, they will be able to send directed e-mails to a dedicated shopping “inbox” with discounts available only to that user

a. The pages of the website may have advertising from third parties.

b. The system may send coupons, newsletters and/or emails to the user.

Security CAPTCHA

a. The system can have a security authentication Item at the end of signup.

Security

a. Vast security is built into the system.

b. There is double authentication on login.

c. All user info is stored in encrypted form.

d. Upon subscribing to use the system, a security validation email is sent to the user's email address to insure that it is that user that has joined under his name.

e. Extensive anti-virus and anti-spam programs will be employed.

f. There is an alert if anyone logs into the user's account, with or without permission.

Widgets

The system provides the ability to choose from thousands of widgets to place on the user's home page. The widgets may be stored in a searchable database of the system, or the system may retrieve selected widgets from the Internet upon request by the user.

Phone and Mobile Pad Applications

Phone and mobile pad applications will be available on all major phone and mobile pad platforms.

When the user accesses the website after setting up an account, she is presented with a web page transmitted from the website and rendered on the user's device that provides a number of options. The user enters her login information into the browser program of her device, which is transmitted over the Internet to the website. In one embodiment, the login information is detected using a reader or other interrogator and transmitted to the website. The website searches its database for file information associated with the login information. Stored information can include the URLs of social media sites registered by the user, login information for the various social media sites of the user, URLs of other sites from which the user access information via the Internet, login information for other sites from which the user access information via the Internet and other preferences set up by the user during setup of the account or through changes made to the account after setup.

The website then communicates with the various Internet sites and applications by use of an application programming interface (“API”) through a series of calls using protocols such as XML. An API comprises a series of XML messages, each corresponding to a different function such as logon, post messages, receive messages, etc. The website stores in a searchable database the API for each separate Internet site and application, which information is retrieved when a user requests information from that Internet site, service or application.

The Information Ticker can start to scroll across the user's display. In one embodiment, each item that scrolls on the ticker is preceded by a small emblem, such as a diamond, that corresponds to color of the category of that item within the website of the invention. For example, if the item is a social network item, the diamond will be blue if social networks are coded as blue on the user's dashboard; if the item is a email item, it could be color coded pink; if the item is a calendar item, it could be color coded green. This allows the user to easily identify what type of item is scrolling on the ticker. The user can customize the ticker, for example by adding only what he wants to view. The user also has the ability to turn the ticker off and on as desired. In one embodiment, the system may scroll advertisements or other messages in the ticker.

The user decides which services and applications to display on her screen. Multiple services/applications may be displayed according to the layout decided by the owner of the website and/or the user. Information from the user's selected services and applications will be aggregated together according to like services/applications. For example, information from all social media services will be aggregated on a social media screen. The user may view any combination of her social media sites on the social media screen. The user may open and close screens at will.

Information can be updated in the website databases, such as ownership changes, however security measures can be employed to maintain confidentiality and security of the information. Information in the databases can be encrypted for additional confidentiality and security.

The system further comprises an application through which the user selects one or more keywords and one or more services and applications. All existing and incoming information in those services and applications that are found by searching using the selected keywords are displayed on the user's device. The services and applications can be searched by any method now known or later developed, for example Boolean searching that combines the selected keywords with operators such as AND, NOT and OR to further produce more relevant results.

The user can elect to set up a “funnel” which comprises selecting one or more keywords and one or more of the user's selected services and applications. When the funnel is “active,” all information on those selected services and applications are searched using the keyword(s) and the results are displayed on the user's device or screen. The user can “inactivate” the funnel; delete the funnel; or change the services and applications to be searched for the selected keyword(s). The services and applications can be searched by any method now known or later developed, for example Boolean searching that combines the selected keywords with operators such as AND, NOT and OR to further produce more relevant results.

In one embodiment, the selected services and applications selected by a user to be searched in a particular funnel are analyzed by keyword, and may be searched and/or presented to the user chronologically. The selected services and applications that can be analyzed in a user's funnel can comprise disparate sources such as email, news, RSS feeds, social media and financial data, and including combinations of such disparate sources. In one embodiment, an algorithm may search services and applications selected by a user to be searched in a particular funnel by relevance of a keyword to the overall content of the searched services and applications. For example, in this embodiment, a keyword found in a headline or having other prominence in the content may give greater weight to a particular source over a source containing the keyword in a random manner. In one embodiment, the algorithm can suggest other words and/or terms to search based on the user's selected keyword(s). In one embodiment, the system and method can be scheduled by the user to select time periods for content collection without having to be logged in to the system.

The website can be a “cloud” based application and does not necessarily reside on the user's computer or device. As compared to a browser plugin, or desktop-based system, web-based means no complicated configuration or software installation is required by the user. Also, the website can stay on top of changes released by the various social networks and can deploy those changes/features in a much more expeditious manner. Further, the cloud-based infrastructure affords virtually limitless expansion of the website. Another advantage of being web-based is that additional services to the website can be added ‘behind-the-scenes’ and then deploy those changes to the entire user-base with ease.

In order to provide a high level of service and reliability to the most users possible while utilizing as little hardware as possible in the web-based application, the website provides a mechanism that allows users to receive updates to any available online information, including but not limited to their social and messaging streams, in real-time without requiring the users' browsers to constantly poll the users' different services (Facebook®, Twitter®, etc.) at predefined intervals. This mechanism is driven by a custom piece of server software. In one embodiment, the custom server software is written in C® and runs on Linux® environments on multiple servers that are referred to as APP (application) servers. The customer server software functions as follows:

Step 1. A user logs into the web-based application. During the login process, the web-based application determines which APP server in the collection of APP servers associated with the web-based application is the least busy at that moment and saves it into the user's session.

Step 2. Once the user reaches any page within the web-based application after logging in, his/her browser launches a background HTTP/HTTPS request that connects to the APP server that was selected during the login for that session.

Step 3. When the software on the APP server receives the HTTP/HTTPS request from the user's browser, it retrieves all of the user's access information for the different third-party services the user has set up (Facebook®, Twitter®, etc.) from the main application's SQL server and creates an entry in an internal queue called the service update queue. After creating the entry in the queue, the server software does not send a response and leaves the connection open. This forces the user's browser to stay connected to the server indefinitely.

Step 4. The APP server software then goes through all of the users in the service update queue and checks all of their services for updates at service specific intervals. If the APP finds that there have been no updates on any of a specific user's services, nothing happens and the checks are run again at the next predefined interval while the user's browser stays connected. If the service checks do find that one or more services do have new information, a response gets sent to the user's browser indicating that an update has occurred and that the screens in the application (social and/or messaging streams) need to be updated.

Step 5. When the user's browser receives an update notification from the APP server it is connected to, it will process the update and then re-connect to the APP server to continue listening for more updates.

Step 6. When the user leaves the site or closes their browser, the APP server the user was connected to will detect it and then remove them from their service update queue.

In the process of continuously checking all of the user's services for updates, the software on the APP servers stores the responses from the different services for use by the main web application. For example, since the main web application has to constantly check the user's Facebook® news feed in order to determine if there are any new entries, it will save the information it retrieves whenever an update does occur so that when the application refreshes its Facebook® data, it can retrieve it from there instead of re-requesting it from Facebook® a second time.

Each of the APP servers have other processes running on them that will determine the current load (amount of connections) being handled by each of them. This process runs at regular intervals and connects to the application's SQL database and updates a field indicating which server currently has the least amount of load. The website uses this information to determine which APP server to direct users to when they log in.

The website is free to the subscriber in one embodiment. In one embodiment, the website may charge a monthly or annual fee to access the system. The fee may be charged according to the user's usage of the system. In all embodiments, the system tracks the usage of the system for each user.

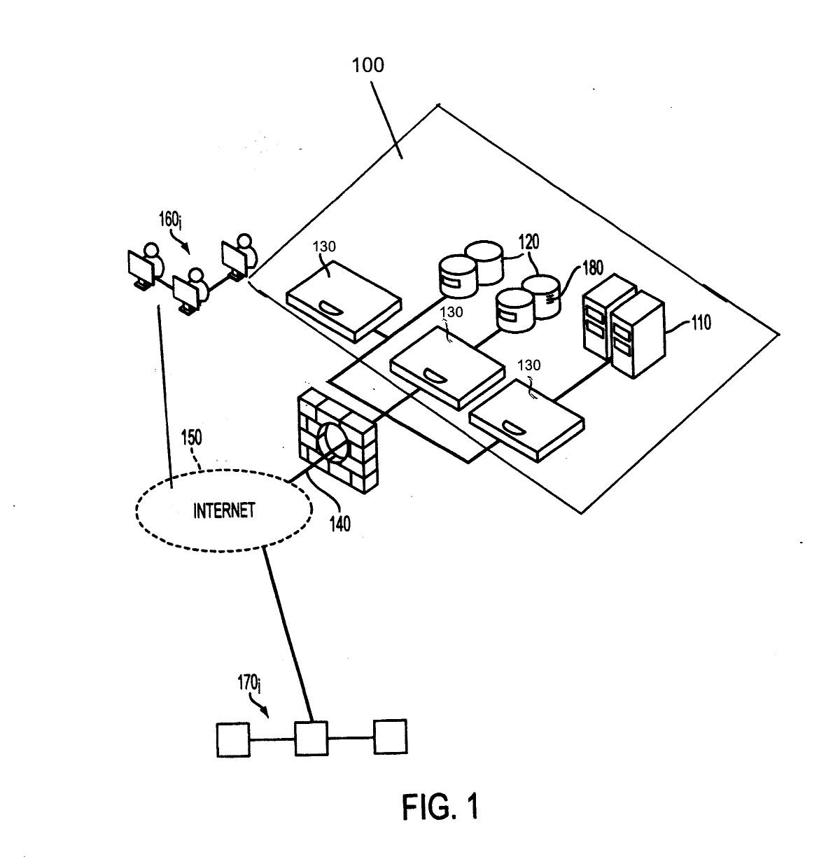

Turning to the figures, FIG. 1 is a schematic depicting one embodiment of the system of the invention. The system comprises a website 100 hosted on one or more application servers 110. Website 100 further comprises one or more databases 120, one or more programmable processors 130 and a communications link 140 to a communications network 150. Website 100 is accessible over the communications network 150 to a plurality of users 160i as well as plurality of Internet-available services and applications 170i. Databases 120 are configured to store in master file 180 information relating to a user 160i, one or more Internet-available sites, services or applications from which user 160i desires to access and aggregate information. Databases 120 are further configured to store information relating to accessing Internet-available services and applications, such as through APIs. Programmable processor 130 of website 100 can be configured to access information in database 120 in response to inputs by user 160i, as well as to commands from website 100 and communications received from Internet-available services and applications 170i.

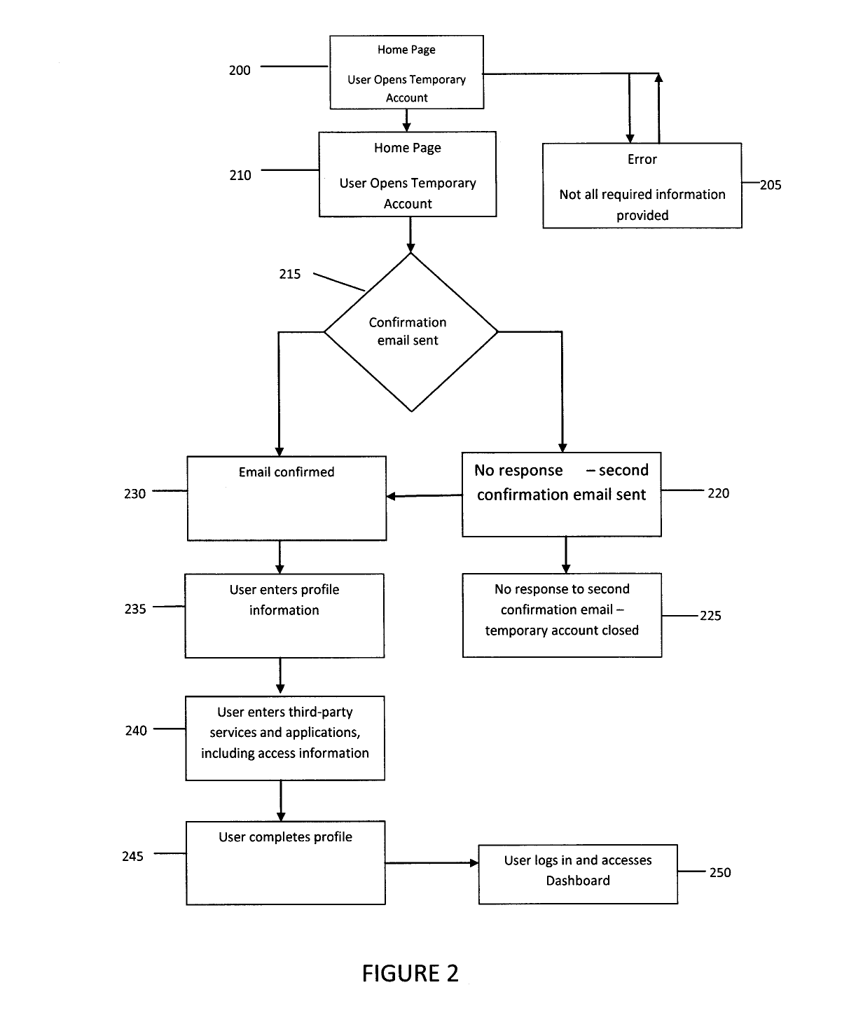

FIG. 2 is a flowscheme of signing up for the service of one embodiment of the invention. At 200, a user accesses the home page of the website of the system and sets up a temporary account by entering basic information about himself, including an active email. If the user does not fill out all required information, he is given an error message at 205 and is returned to the home page to provide the missing information. At 210, the user is challenged to show that he is not a computer. If he successfully completes the challenge, at 215 he is sent an email at the email address entered at 200 to confirm that the email address is active. If the user does not confirm in response to the email sent at 215, at 220 a second email is sent. If the user does not confirm in response to the second email, at 225, the temporary account is deleted. If the user confirms in response to the email, at 230 the user (who is now a member) is asked to complete his profile. At 235, the user enters profile information such as sex, birth date, residence or any other information desired to be acquired by the system. At 240, the user selects the services and applications to be accessed through the system. At 245, the user account is set up. At 250, the user can log in to the system and access his dashboard, where he can access services and applications.

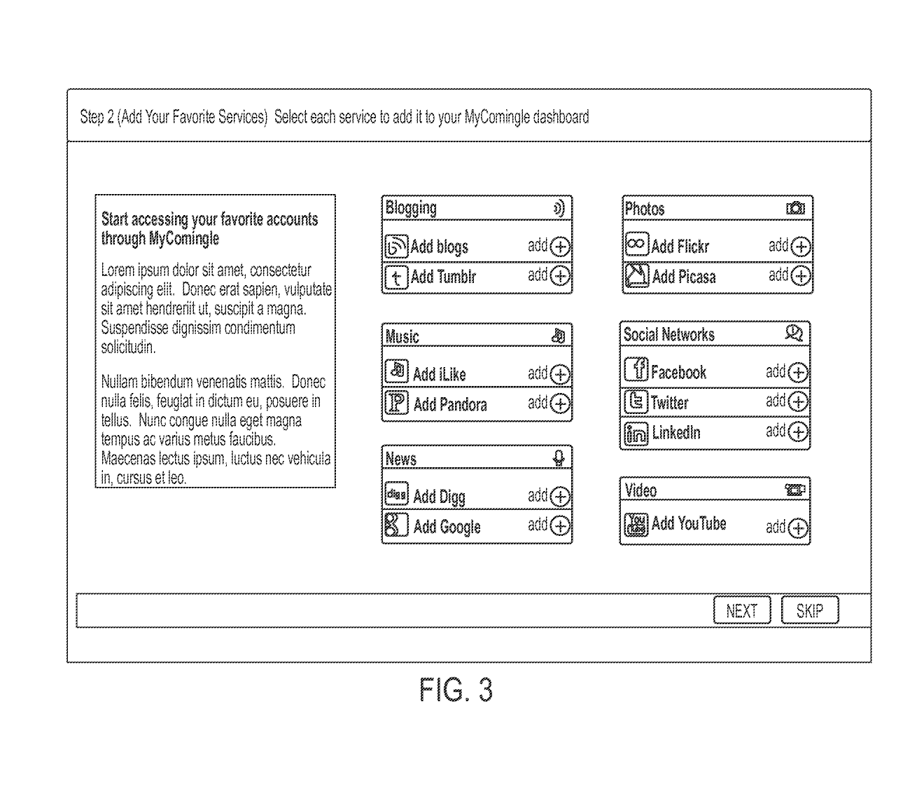

FIG. 3 depicts a screenshot showing various services and applications that could be offered for selection by a user of the service according to one embodiment of the invention.

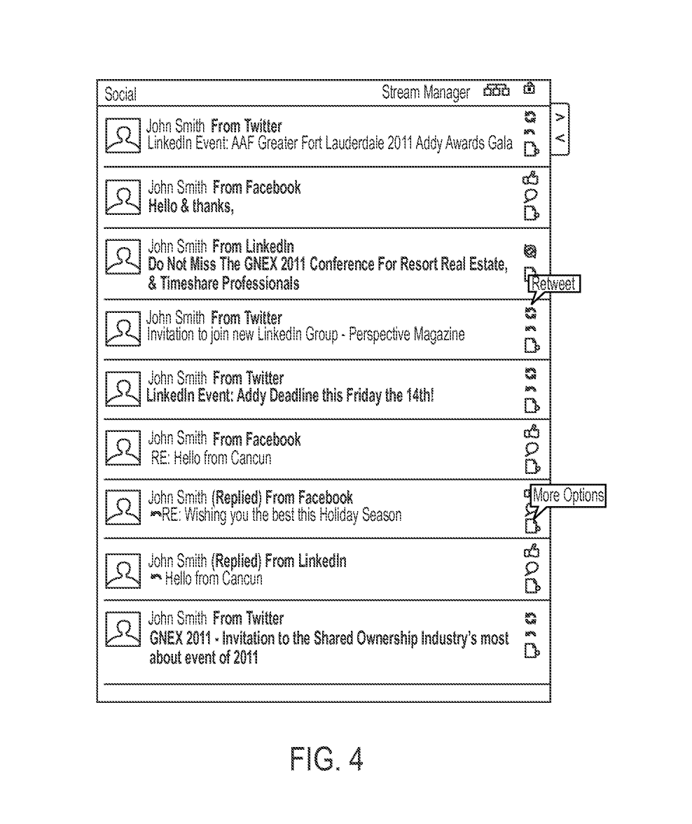

FIG. 4 depicts a screenshot from the account of a user who has aggregated various social media services for viewing in a single screen according to one embodiment of the invention. The user can, for example, “retweet” or select other options for postings on his social media screen.

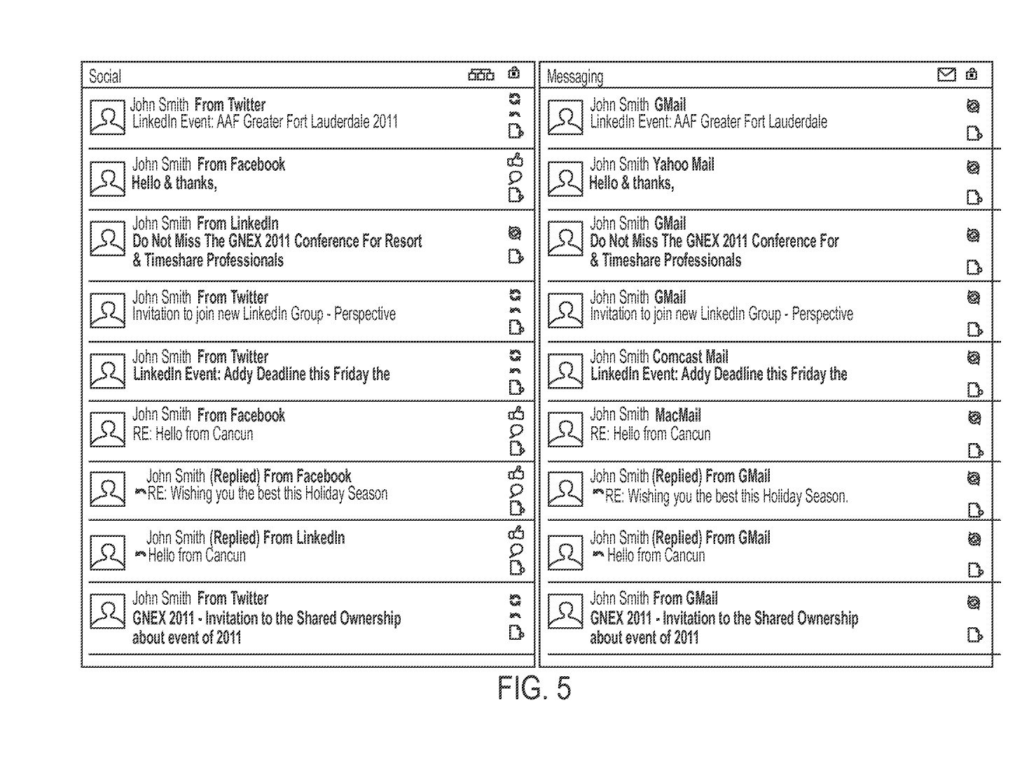

FIG. 5 depicts a screenshot from the account of a user who has aggregated various social media services and also aggregated various messaging services and applications for viewing in a single screen according to one embodiment of the invention.

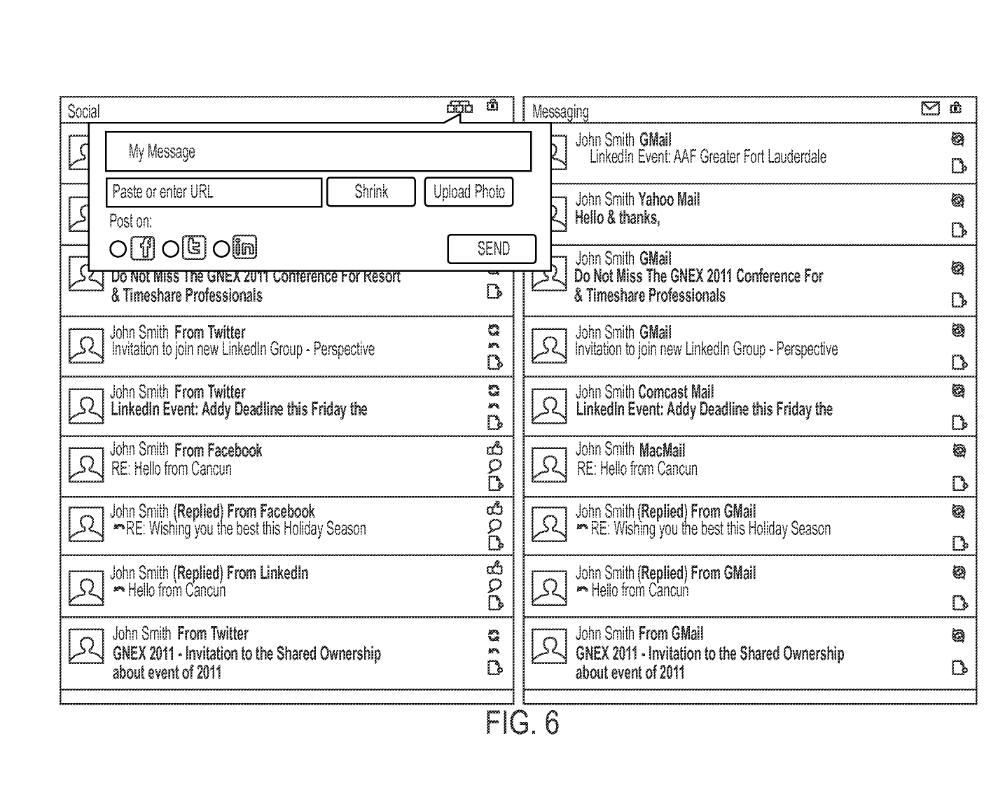

FIG. 6 depicts a screenshot from the account of a user who is posting a message on one or more of the social media services aggregated in the user's account according to one embodiment of the invention. The user can select any combination of his social media to post a message.

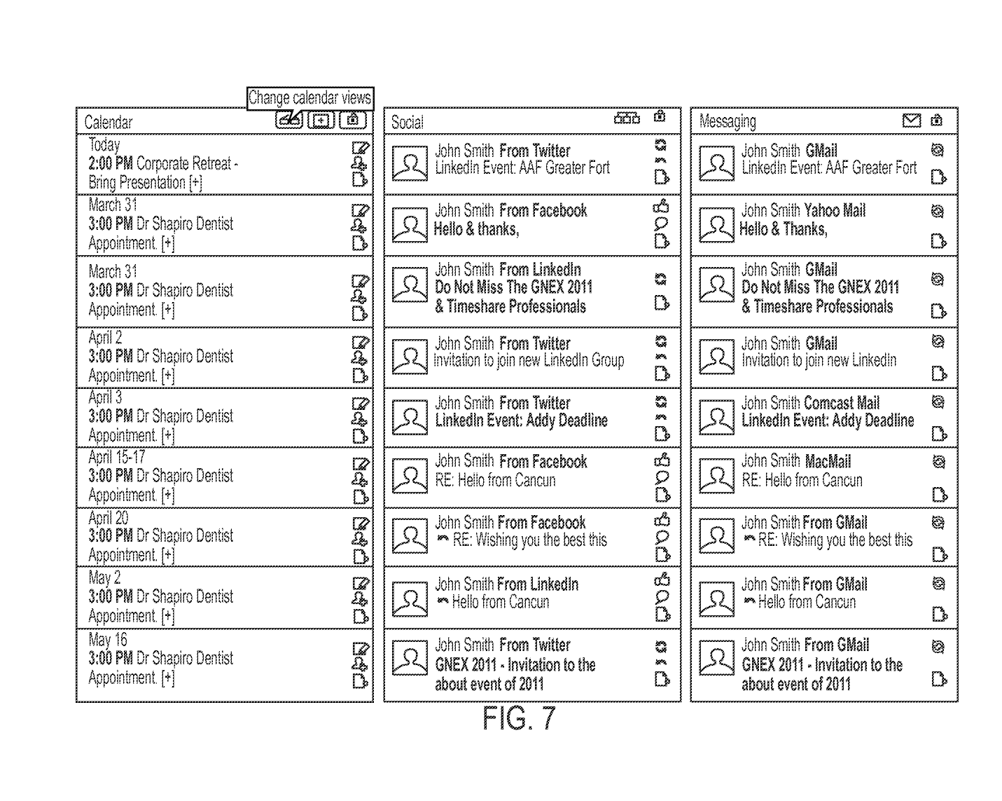

FIG. 7 depicts a screenshot from the account of a user who has aggregated various social media services; who has also aggregated various messaging services and applications; and who has also aggregated various calendar entries for viewing in a single screen according to one embodiment of the invention.

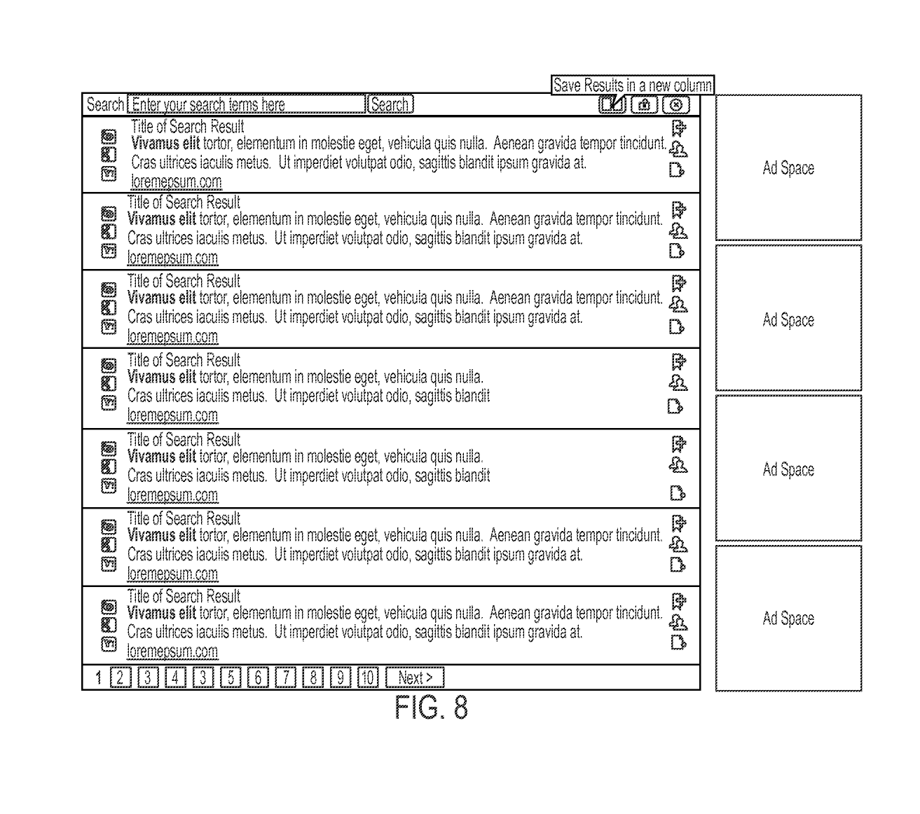

FIG. 8 depicts a screenshot from the account of a user who has conducted an Internet search and who has aggregated organic search results from a plurality of search engines for viewing in a single screen according to one embodiment of the invention. In one embodiment of the invention, repetitive search results from the various search engines are deleted.

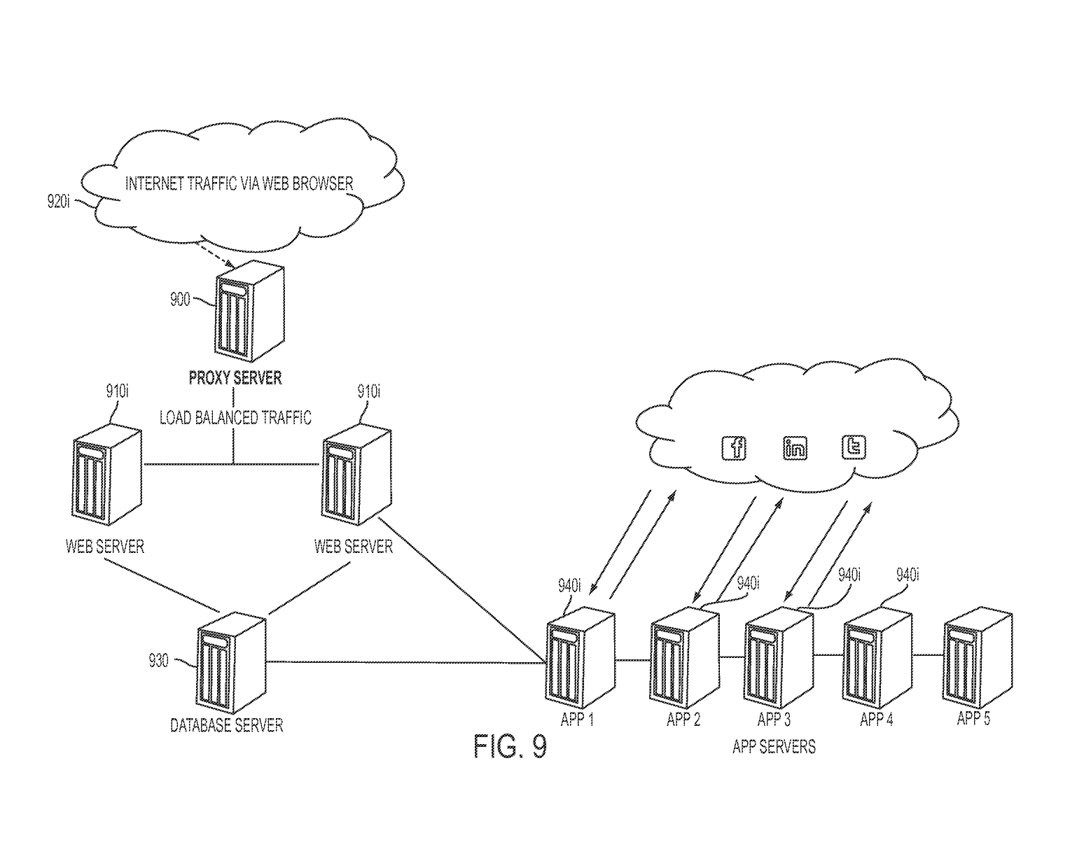

FIG. 9 is a schematic depicting custom server software which allows users to receive updates to any available online information in real-time without requiring their browsers to constantly poll their different services at predefined intervals. Proxy server 900 is in communication with a plurality of web servers 910i and also a plurality of users via their web browsers 920i. Web servers 910i communicate with database (SQL) server 930 as well as application servers 940i. Web servers 910i determine which application server 940i to route the web-based application based on the current traffic being served by each application server 940i. The specific application server 940i is saved into the user's session. Once the user reaches any page within the web-based application after logging in, his/her browser 920i launches a background HTTP/HTTPS request that connects to the APP server 940i that was selected during the login for that session. When the software on the APP server 940i receives the HTTP/HTTPS request from the user's browser 920i, it retrieves all of the user's access information for the different third-party services the user has set up (Facebook®, Twitter®, etc.) from the main application's SQL server 930 and creates an entry in an internal queue called the service update queue. After creating the entry in the queue, the server software does not send a response to the user's browser 920i and leaves the connection open. This forces the user's browser 920i to stay connected to the server indefinitely. The application server software then goes through all of the users in the service update queue and checks all of their services for updates at service specific intervals. When the user's browser 920i receives an update notification from the application server 940i it is connected to, it will process the update and then re-connect to the application server 940i to continue listening for more updates. When the user leaves the site or closes his browser 920i, the application server 940i that the user was connected to will detect it and then remove that user from its service update queue. In the process of continuously checking all of the user's services for updates, the software on the application server 940i stores the responses from the different services for use by the main web application. While proxy server 900 is shown as a separate server, in other embodiments proxy server 900 could be a part of another server in the system.

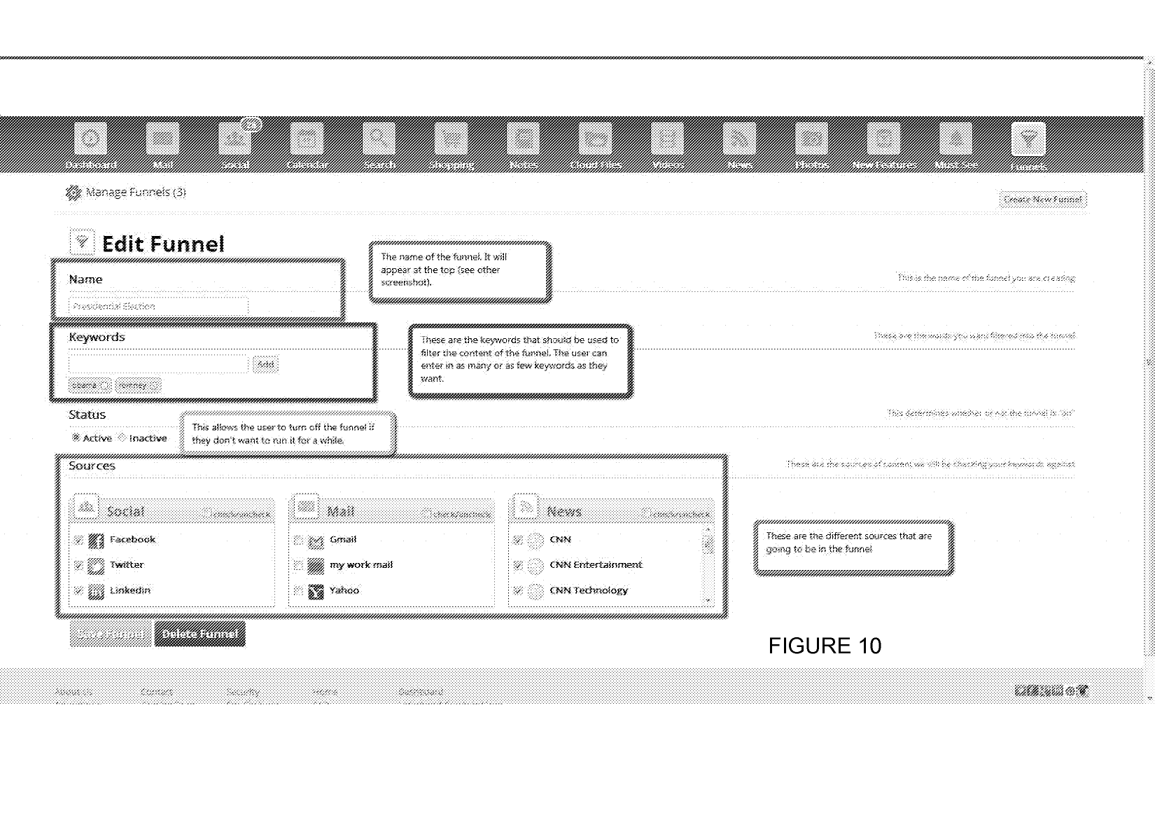

FIG. 10 depicts a screenshot from the account of a user who has selected one or more keywords to search the information contained in one or more services and applications previously selected by the user.

It should be understood that any calculations may be performed by any suitable computer system, such as that diagrammatically shown in FIG. 1. Data is entered into system via any suitable type of user interface, and may be stored in memory, which may be any suitable type of computer readable and programmable memory. Calculations are performed by processor, which may be any suitable type of computer processor and may be displayed to the user on display, which may be any suitable type of computer display.

Processor may be associated with, or incorporated into, any suitable type of computing device, for example, a personal computer or a programmable logic controller. The display, the processor, the memory, and any associated computer readable recording media are in communication with one another by any suitable type of data bus, as is well known in the art.

Examples of computer readable recording media include a magnetic recording apparatus, an optical disk, a magneto-optical disk, and/or a semiconductor memory (for example RAM, ROM, etc.). Examples of magnetic recording apparatus that may be used in addition to memory, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system of aggregating and displaying information obtained from the Internet, comprising:
(a) a website hosted on one or more application servers;
(b) one or more searchable databases hosted on one or more database servers, wherein the database servers are in communication with the application servers;
(c) a programmable processor in communication with the application servers and the database servers; and
(d) a communications link connecting the website to a communications network to a plurality of user web-enabled devices, wherein each user accesses the website through a browser program resident on the user web-enabled devices;
wherein the application servers communicate with a plurality of services and applications available on the Internet via application programming interfaces and exchange information with those services and applications, wherein further the information received from the services and applications are displayed on the user web-enabled devices in response to predetermined selections made by the user.

2. The system of claim 1, wherein the user selects information to display via the website by setting up an account with the system, selecting one or more services or applications available on the Internet wherein the services and applications are categorized into predefined categories, providing login information for the one or more selected services or applications, logging onto the system and selecting one or more of the predefined categories to display on the display of the user's web-enabled device.

3. The system of claim 2, wherein the predefined categories comprise social media, instant messaging, calendar, email, and Internet search.

4. The system of claim 3, further comprising an information ticker, wherein the information ticker scrolls across the display of the user web-enabled device.

5. The system of claim 4, wherein the user selects items to be displayed in the information ticker.

6. The system of claim 5, wherein the items comprise calendar appointments, calendar events, RSS fees, social network updates, instant messages and emails.

7. The system of claim 6, wherein the user selects an item in the information ticker as it appears on the display of the user web-enabled device and opens the item.

8. The system of claim 7, wherein the items in the information ticker are color coded to correspond to predefined categories.

9. The system of claim 8, wherein the information ticker ceases scrolling when the user places a cursor of the user web-enabled device over an item contained in the information ticker.

10. The system of claim 3, wherein the user posts a message simultaneously on one or more of the social media services displayed on the user web-enabled device.

11. The system of claim 3, wherein results of Internet searches run on multiple Internet search applications are displayed in a single display on the user web-enabled device.

12. A method of using a proxy server that allows users to receive updates to any available online information in real-time without requiring their browsers to constantly poll their different services at predefined intervals, comprising:
(a) determining which of a plurality of application servers in communication with a proxy server has the least load and storing the identification of that application server in a session of a user of a web-based system;
(b) receiving a background HTTP/HTTPS request launched by the user's browser that connects to the application server that was selected for that session;
(c) retrieving access information for a plurality of the user's third-party Internet services and application from a database hosted on a database server in communication with the selected application server and creating an entry in an internal service update queue;
(d) refraining from responding to the browser HTTP/HTTPS request thus keeping the browser connected to the application server;
(e) inquiring at predetermined time intervals for updates to all of the user services and applications for users included in the internal service update queue;
(f) transmitting to the user browser updates received by the selected application server in response to its inquiries for updates to the user services and applications;
(g) reconnecting the user browser to the application server; and
(h) deleting the user from the service update queue of the selected application server upon closing of the user browser.

13. The method of claim 12, wherein the third-party services and applications comprise calendar appointments, calendar events, RSS fees, social network updates, instant messages and emails.

14. The method of claim 13, wherein at least some of the updates are included in an information ticker that scrolls across the display of a user web-enabled device.

15. A computer software product that includes a non-transitory storage medium readable by a processor, the non-transitory storage medium having stored thereon a set of instructions for having a server serve as a proxy for a user's browser, the instructions comprising:
(a) a first sequence of instructions which, when executed by the processor, causes the processor to determine which of a plurality of application servers in communication with a proxy server has the least load and store the identification of that application server in a session of a user of a web-based system;
(b) a second sequence of instructions which, when executed by the processor, causes the web browser of the user to launch a background HTTP/HTTPS request that connects to the application server that was selected for that session;
(c) a third sequence of instructions which, when executed by the processor, causes the selected application server to retrieve access information for a plurality of the user's third-party Internet services and application from a database hosted on a database server in communication with the selected application server and creates an entry in an internal service update queue;
(d) a fourth sequence of instructions which, when executed by the processor, causes the selected application server to refrain from responding to the browser HTTP/HTTPS request thus keeping the browser connected to the application server;
(e) a fifth sequence of instructions which, when executed by the processor, causes the selected application server to inquire at predetermined time intervals for updates to all of the user services and applications for users included in the internal service update queue;
(f) a sixth sequence of instructions which, when executed by the processor, causes the user browser to process updates received from the selected application server in response to its inquiries for updates to the user services and applications;
(g) a seventh sequence of instructions which, when executed by the processor, causes the user browser to reconnect to the selected application server and to continue to listen for further updates; and
(h) an eighth sequence of instructions which, when executed by the processor, causes the application server to delete the user from its service update queue upon closing of the user browser.

16. The computer software product of claim 15, wherein the third-party services and applications comprise calendar appointments, calendar events, RSS fees, social network updates, instant messages and emails.

17. The computer software product of claim 16, further comprising:
(i) a ninth sequence of instructions which, when executed by the processor, causes at least some of the updates are included in an information ticker that scrolls across the display of a user web-enabled device.

18. A system of aggregating and displaying information obtained from the Internet, comprising:
(a) a website hosted on one or more application servers;
(b) one or more searchable databases hosted on one or more database servers, wherein the database servers are in communication with the application servers;
(c) a programmable processor in communication with the application servers and the database servers;
(d) a communications link connecting the website to a communications network to a plurality of user web-enabled devices, wherein each user accesses the website through a browser program resident on the user web-enabled devices; and
(e) a content search unit programmed to search content,
wherein the application servers communicate with a plurality of services and applications available on the Internet via application programming interfaces and exchange information with those services and applications, wherein further the information received from the services and applications are displayed on the user web-enabled devices in response to predetermined selections made by the user,
wherein the user selects one or more keywords and one or more services and applications, wherein the content search unit searches the selected services and applications for the keywords and the content search results are displayed on a display in communication with the system,
wherein the system further comprises a server as a proxy for a user's browser, comprising:
a proxy server in communication with a plurality of web servers and a plurality of users via their web browser;
a database server in communication with the web servers and a plurality of application servers; and
a plurality of third-party services available on the Internet,
wherein the web servers are configured to determine which of the application servers in communication with a proxy server has the least load and store the identification of that application server in a session of a user of the system;
wherein further the system receives a background HTTP/HTTPS request launched by the user's browser that connects to the application server that was selected for that session;
wherein further the selected application server retrieves access information for a plurality of the user's third-party Internet services and application from a database hosted on the database server and creates an entry in an internal service update queue;
wherein further the system refrains from responding to the browser HTTP/HTTPS request thus keeping the browser connected to the application server;
wherein further the selected application server inquires at predetermined time intervals for updates to all of the user services and applications for users included in the internal service update queue;
wherein further the system transmits to the user browser updates received by the selected application server in response to its inquiries for updates to the user services and applications;
wherein further the system reconnects the user browser to the application server; and
wherein further the user is deleted from the service update queue of the selected application server upon closing of the user browser.

19. The system of claim 18, wherein the third-party services and applications comprise calendar appointments, calendar events, RSS fees, social network updates, instant messages and emails.

20. The system of claim 19, further comprising an information ticker, wherein the information ticker scrolls across the display of a user web-enabled device, wherein at least some of the updates are included in the information ticker.
